(19) United States
(12) Patent Application Publication
(10) Pub. No.: US 2010/0270090 A1
(43) Pub. Date: Oct. 28, 2010

(54) Electromagnetic Input Apparatus

(75) Inventors: Yun-Hsiang Yeh, Miaoli (TW); Yi-Ting Chen, Hsinchu (TW)

Correspondence Address: SQUIRE, SANDERS & DEMPSEY L.L.P., 275 BATTERY STREET, SUITE 2600, SAN FRANCISCO, CA, 94111-3356, US

(73) Assignee: WALTOP INTERNATIONAL CORPORATION, Hsinchu (TW)

(21) Appl. No.: 12/605,100

(22) Filed: Oct. 23, 2009

(30) Foreign Application Priority Data
Apr. 23, 2009 (TW) 098113469

(51) Int. Cl. G06F 3/041

(52) U.S. Cl. 178/19.01

(57) ABSTRACT

An electromagnetic input apparatus is disclosed. The electromagnetic input apparatus comprises an electromagnetic sensor board and an input pen. The input pen has a horizontal arranged ferrite core and a coil. The electromagnetic sensor board has a plurality of antenna loops. Each row and column have a plurality of antenna loops, and each antenna loop surrounds a region so as to divide the electromagnetic sensor board into a plurality of regions.

### 1. FIELD OF THE INVENTION

The present invention relates to an electromagnetic input apparatus, and more particularly to a multi-angle electromagnetic input apparatus.

### 2. DESCRIPTION OF THE PRIOR ART

Electromagnetic input apparatuses such as electronic white boards are widely utilized in conference or education occasions. Electronic white boards comprise interactive electronic white boards and non-interactive electronic white boards. Interactive electronic white boards are usually used with a projector to project contents processed by a computer on the whit board, and such combination renders the interactive electronic white board an interactive touch display or screen of a computer. Non-interactive electronic white boards are usually used with a printer to output and print contents wrote on the white board without a computer.

FIGS. 1A and 1B show schematic principle of conventional electromagnetic input apparatuses. The conventional electromagnetic input apparatus comprises a white board having an electromagnetic sensor board therein and an input pen. The electromagnetic sensor board includes antenna loops as shown in FIGS. 2A to 2C. FIGS. 2A and 2B show X direction and Y direction antenna loops of an electromagnetic sensor board respectively. FIG. 2C shows the complete antenna loops including the X direction and Y direction antenna loops. The input pen 1 of the conventional electromagnetic input apparatus includes a ferrite core 10 coiled with a coil 12 with a finite number of loops. The conventional electromagnetic input apparatus records the contents wrote thereon through electromagnetic induction between the ferrite core 10 with the coil 12 of the input pen and the antenna loops of electromagnetic sensor board. The ferrite core 10 of the input pen 1 shown in FIG. 1A is arranged along the longitudinal direction of the input pen 1 so that the distribution of the signal waveform received by the antenna loops of an electromagnetic sensor board has peak values around the central region corresponding to the tip of the input pen 1 and symmetric declined waveform patterns at both sides of the central region. However, due to the arrangement of the ferrite core 10 with the coil 12 along the longitudinal direction of the input pen 1, once the input pen 1 tilts toward one side of the central region, the signal values received by the antenna loops at that side would be higher or stronger than that of the other side so as to recognize the inclination of the input pen 1. However, such recognition of the inclination of the input pen 1 by this conventional signal variation detection is limited to one-dimensional. The conventional signal variation detection can not recognize and respond multi-angle posture of the input pen 1 so as to generate corresponding output.

In order to solve the above-mentioned problems, the invention provides a multi-angle electromagnetic input apparatus.

### SUMMARY OF THE INVENTION

An object of the present invention is to provide a multi-angle electromagnetic input apparatus utilizing input pens have a ferrite core arranged along the breadthways direction of the input pen or a ferrite core with a varied shape to change the direction of the magnetic lines of force and multi-check antenna loops and/or checkerboard antenna loops. The multi-angle electromagnetic input apparatus uses the maximum peak value and the secondary peak values of waveform distribution to locate and calculate the coordinates of the width and center of the input pen so that the posture of the input pen including twist and tilt motion or the effect of multi-angle input can be presented

According to the object, one embodiment of the present invention provides an electromagnetic input apparatus comprising an input pen and an electromagnetic sensor board with antenna loops. The input pen has a ferrite core coiled with a coil arranged along the breadthways direction of the input pen, and the electromagnetic sensor board has antenna loops having a plurality of check loops arranged in column or row so that the electromagnetic sensor board is divided into a plurality of regions each of which is enclosed by the check loop.

The invention also provides an electromagnetic input apparatus comprising an input pen with a ferrite core coiled with a coil arranged along the breadthways direction of the input pen; and an electromagnetic sensor board with an antenna loop, the antenna loops having a plurality of loops arranged along coordinate axes, each loop arranged in column or row and enclosing W/N regions so that the electromagnetic sensor board is divided into a plurality of the regions, wherein W is the width or length of the electromagnetic sensor board, N is the distance between two adjacent regions.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIGS. 1A and 1B show schematic principle of conventional electromagnetic input apparatuses.

FIGS. 2A and 2B show X direction and Y direction antenna loops of an electromagnetic sensor board respectively.

FIG. 2C shows the complete antenna loops including the X direction and Y direction antenna loops.

FIGS. 3A and 3B show schematic principle of electromagnetic input apparatuses of two of embodiments of the invention.

FIG. 4 shows peak values of signal waveform distribution around the central region corresponding to the tip of the input pen 3 or 3′ and corresponding trace dots of the tip of the input pen.

FIGS. 5A-5C show embodiments of antenna loops of an electromagnetic sensor board of the invention respectively.

FIG. 6 shows that the coordinates of the check loops g and s can be calculated through the peak values of signal waveform sensed at the check loops f, h, b and l, and r, t, n and x respectively.

FIGS. 7A-7C show embodiments of antenna loops of an electromagnetic sensor board of the invention respectively.

FIGS. 8A-8C show embodiments of antenna loops of an electromagnetic sensor board of the invention respectively.

FIG. 9 shows that the coordinates of the check loops B and D can be calculated through the peak values of signal waveform sensed at the check loops designated as the illustrated reference numbers.

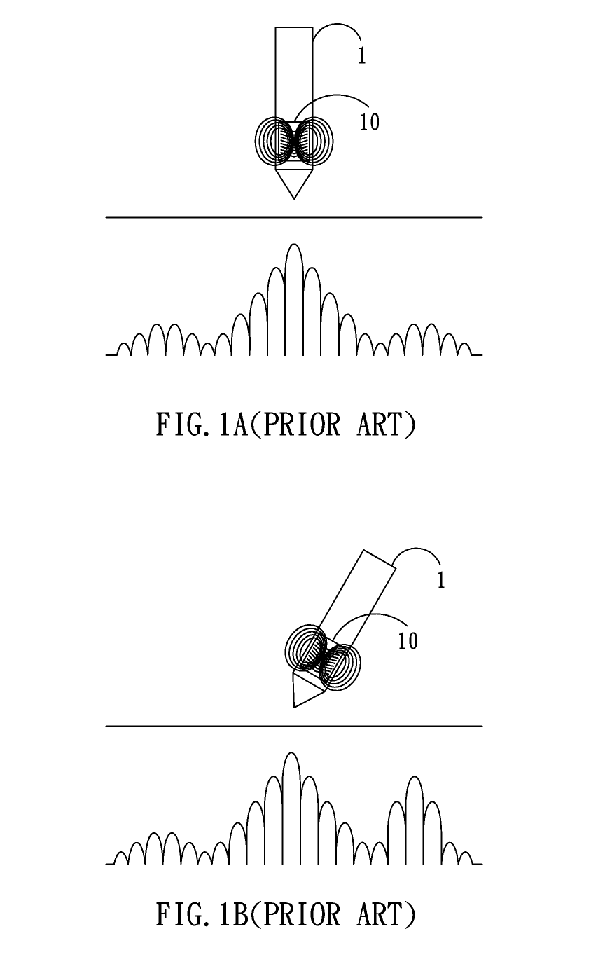

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

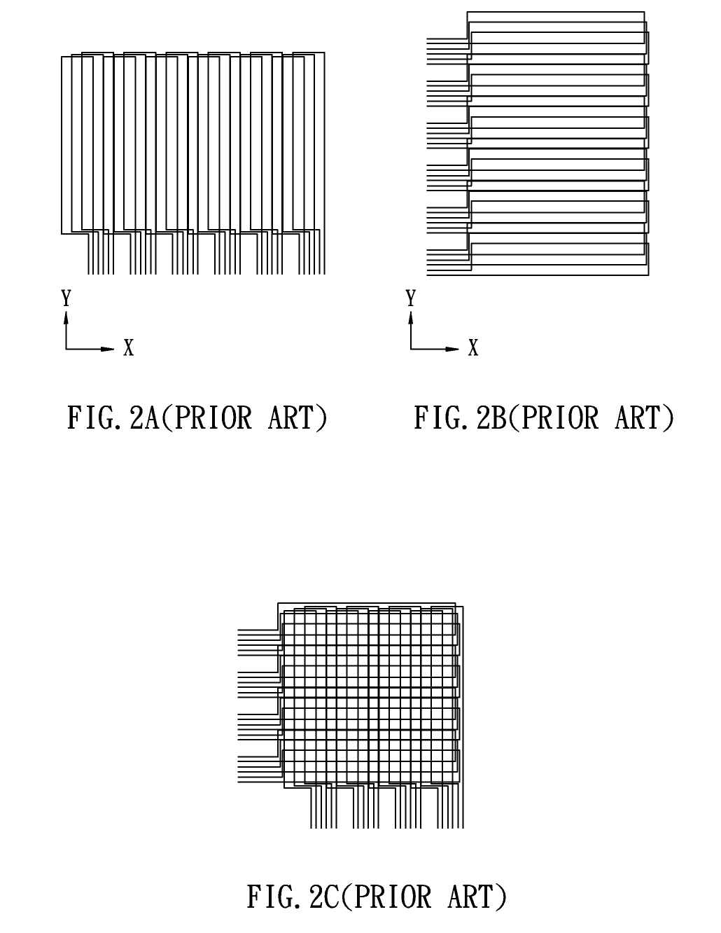

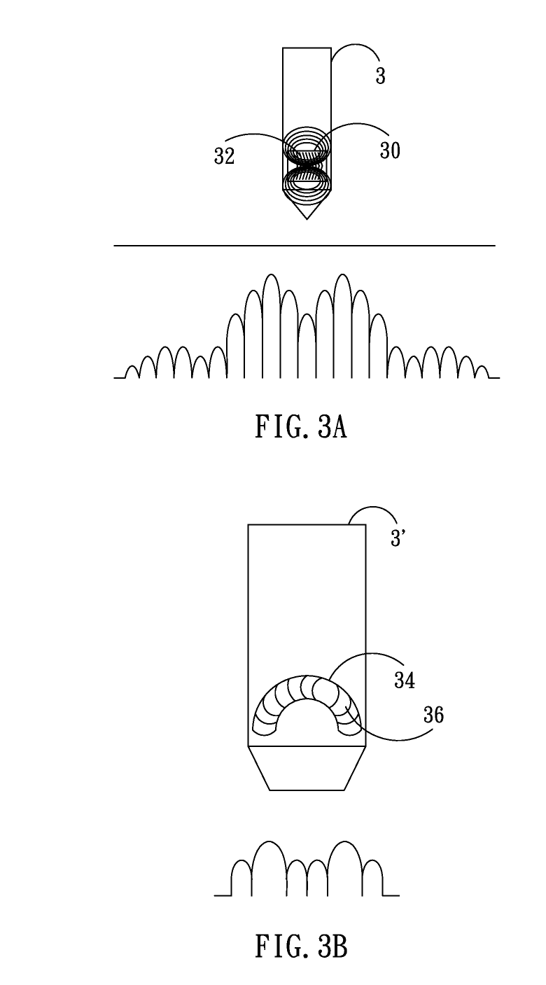

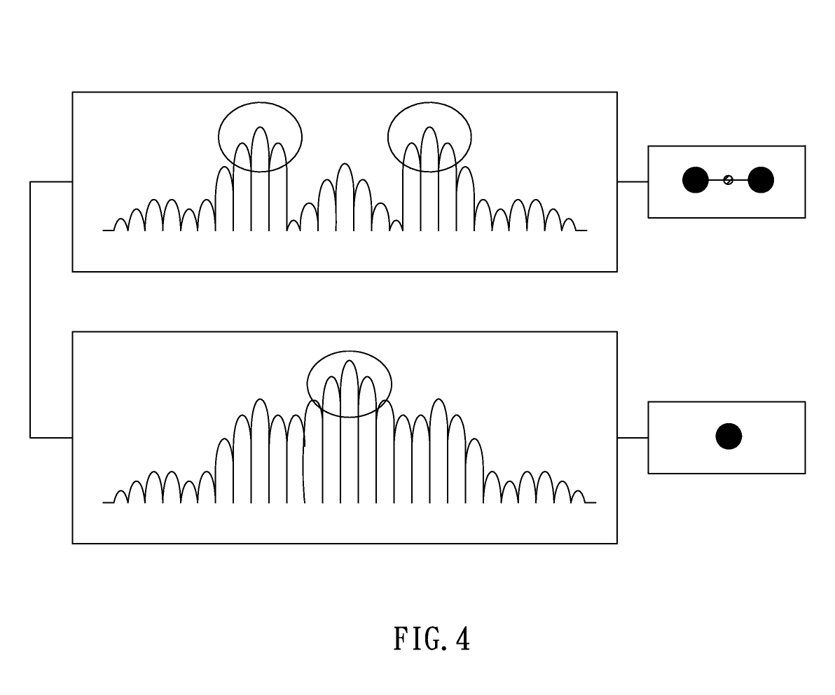

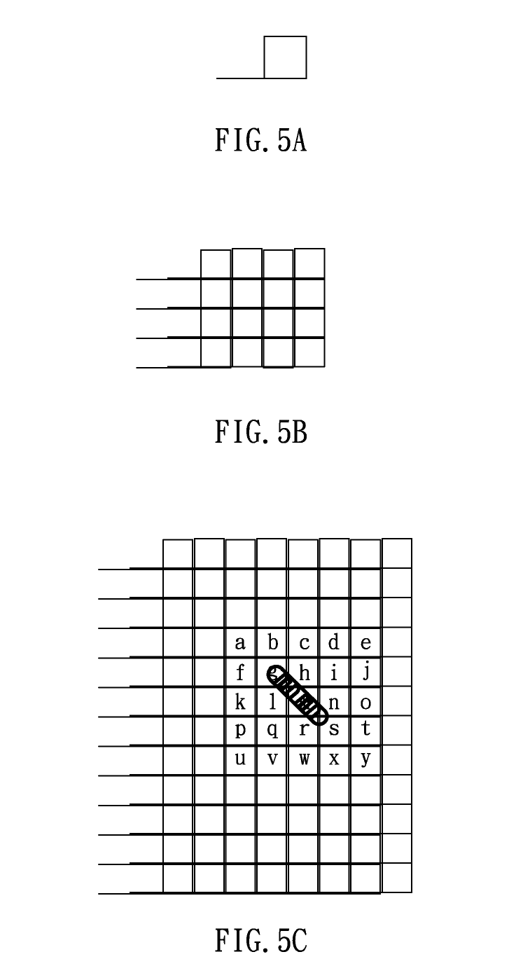

FIGS. 3A and 3B show schematic principle of electromagnetic input apparatuses of two of embodiments of the invention. The electromagnetic input apparatus comprises an input pen and a device having an electromagnetic sensor board. The electromagnetic sensor board has antenna loops shown in FIGS. 5A to 5C, FIGS. 7A to 7C and FIGS. 8A to 8C. The input pen of the invention can also be used on the electromagnetic sensor board has antenna loops shown in FIGS. 2A to 2C.

As shown in FIGS. 3A and 3B, the input pens have a ferrite core arranged along the breadthways direction of the input pen or a ferrite core with a varied shape so as to generate dissimilar magnetic lines of force and signal waveform compared to the conventional one. If the input pens shown in FIGS. 3A and 3B are applied on the electromagnetic sensor board has antenna loops shown in FIG. 2C, electromagnetic signals may neutralize each other along X/Y axes. In order to improve such circumstance, the antenna loops shown in FIGS. 5A to 5C, FIGS. 7A to 7C and FIGS. 8A to 8C are provided in the embodiments of the invention.

Input pens having a ferrite core arranged along the breadthways direction or a ferrite core with a varied shape are shown in FIGS. 3A and 3B respectively. The electromagnetic input apparatus in FIG. 3A includes an input pen 3 having a straight ferrite core 30 coiled with a coil 32 with a predetermined number of conductive loops.

The ferrite core 30 is arranged along the breadthways direction of the input pen 3 and the input pen 3 with such ferrite core 30 would generate two peak values of signal waveform distribution around the central region corresponding to the tip of the input pen 3. The multi-angle posture including the tilt angle of an input device such as the input pen 3 can be calculated by two peak values of signal waveform and two sets of coordinate of the peak values of signal waveform.

FIG. 3B shows that an input pen 3′ having a non-straight ferrite core 34 coiled with a coil 36 with a predetermined number of conductive loops interacts with antenna loops of an electromagnetic sensor board to generate two peak values of signal waveform. In the embodiment of FIG. 3B, the non-straight ferrite core 34 is a U-shape ferrite core with both ends toward the tip of the input pen 3′. The non-straight ferrite core 34 comprises, but not limited to, a U-shape ferrite core. The non-straight ferrite core 34 with both ends toward the tip of the input pen 3′ generates magnetic lines of force similar to that of two straight ferrite cores arranged along the longitudinal direction of the input pen so that electromagnetic signals from both ends of the ferrite core will not neutralize each other when such input pen is used with the electromagnetic sensor board with antenna loops shown in FIGS. 2A to 2C.

The ferrite core 30 and the non-straight ferrite core 34 both would generate two peak values of signal waveform distribution around the central region corresponding to the tip of the input pen 3 or 3′. The coordinate of the tip of the input pen can be calculated by acquiring loops sensing the peak values of signal waveform by the firmware or software of the electromagnetic input apparatus. If there is only one loop sensing peak value of signal waveform acquired, then the posture of the input pen is determined as horizontal. FIG. 4 shows peak values of signal waveform distribution around the central region corresponding to the tip of the input pen 3 or 3′ and corresponding trace dots of the tip of the input pen. The coordinate of the tip of the input pen can be calculated and determined by acquiring loops sensing the peak values of signal waveform when the input pens interact with the electromagnetic sensor board. When two peak values of signal waveform are acquired, the two large trace dots correspond to the coordinates of the two peak values of signal waveform while the small trace dot corresponds to the coordinate of the center of the input pen's tip so that the input pen can presents effects of multi-angle posture and trace line with width. If only one peak value of signal waveform is acquired, the large trace dot corresponds to the coordinate of the center of the input pen's tip and the width of the input pen's tip is set as the minimum value. The width and the coordinate of the input pen's tip can be calculated by the following equation:

$$width = \sqrt{{( {X}^{′} - {X}^{″} )}^{2} + {( {Y}^{′} - {Y}^{″} )}^{2}}$$

$$( X , Y ) = ( \frac{{X}^{′} + {X}^{″}}{2} , \frac{{Y}^{′} + {Y}^{″}}{2} )$$

wherein (X′,Y′) and (X″,Y″) are coordinates of the two peak values of signal waveform.

When the input pens 3 and 3′ in FIGS. 3A and 3B is used with the antenna loops in FIGS. 2A to 2C, the electromagnetic signals generated on two adjacent and partially overlapping antenna loops will neutralize each other since the antenna loops overlap.

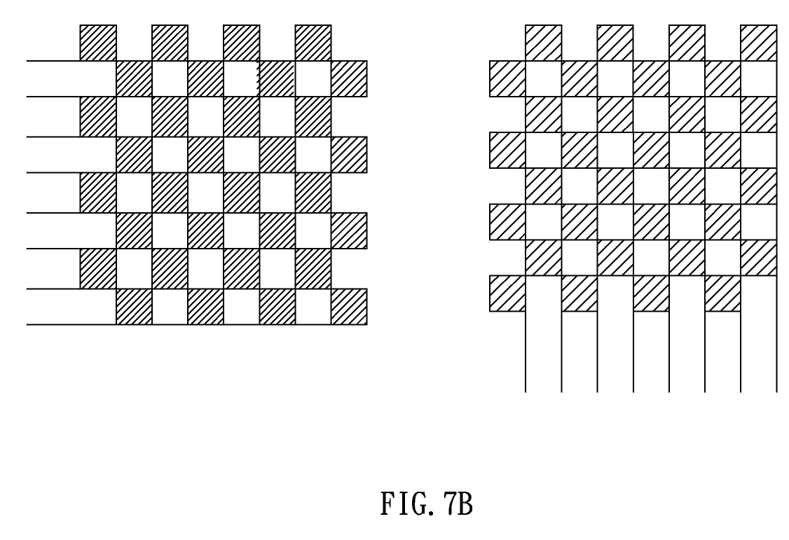

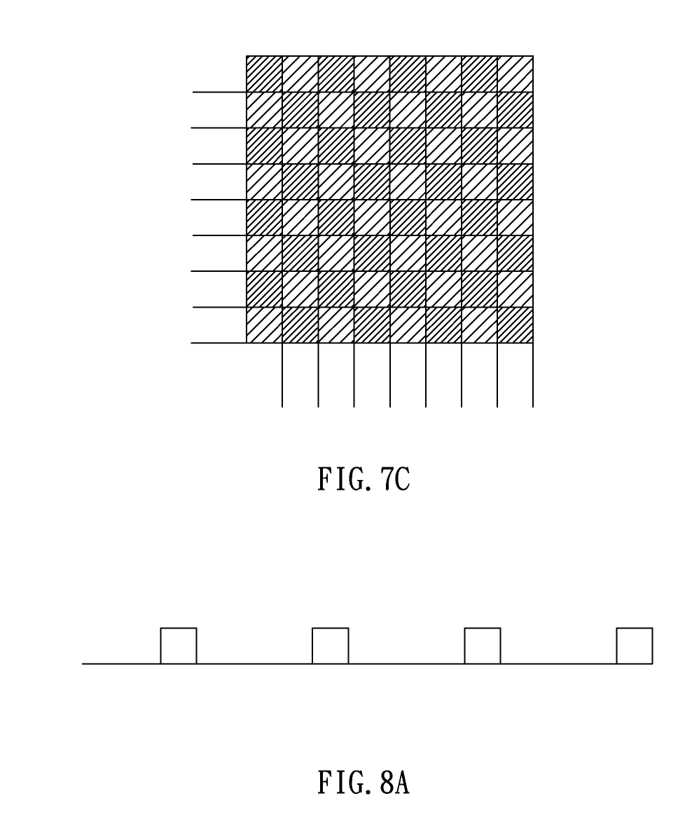

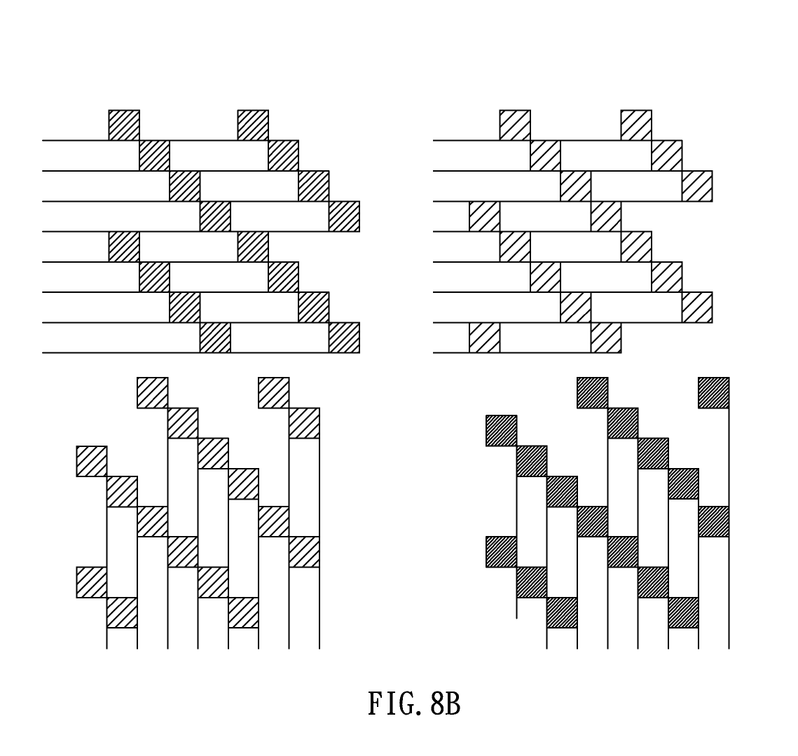

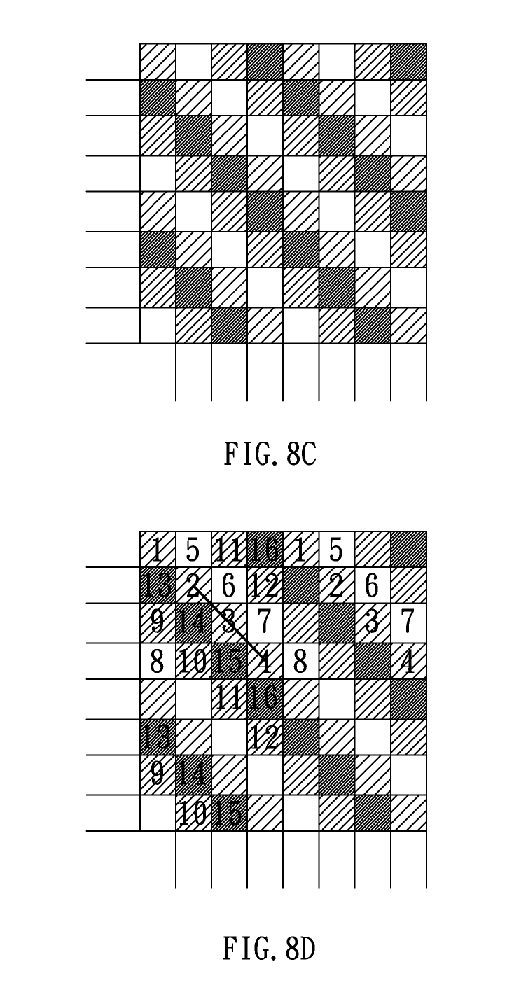

FIGS. 5A-5C, FIGS. 7A-7C, and FIGS. 8A-8C show embodiments of antenna loops of an electromagnetic sensor board of the invention respectively. The antenna loops shown in FIGS. 5A-5C comprise multi-check loops, and the multi-check loops comprise a plurality of check loops or square loops each of which has a switch. The multi-check loops divide the electromagnetic sensor board into multi-region surrounded by the check loop with a switch can precisely recognize and determine the location and strength of electromagnetic signal with a minimum error rate. The antenna loops shown in FIGS. 7A-7C, and FIGS. 8A-8C comprise checkerboard loops, and the checkerboard loops comprise a plurality of loops arranged in column and row along x and y axes square. Each loop has a plurality of checks or squares and one switch to divide the electromagnetic sensor board into multi-region surrounded by the checks or squares. Each loop surround W/N regions, wherein W is the width or length of the electromagnetic sensor board, N is the distance between two adjacent checks or squares.

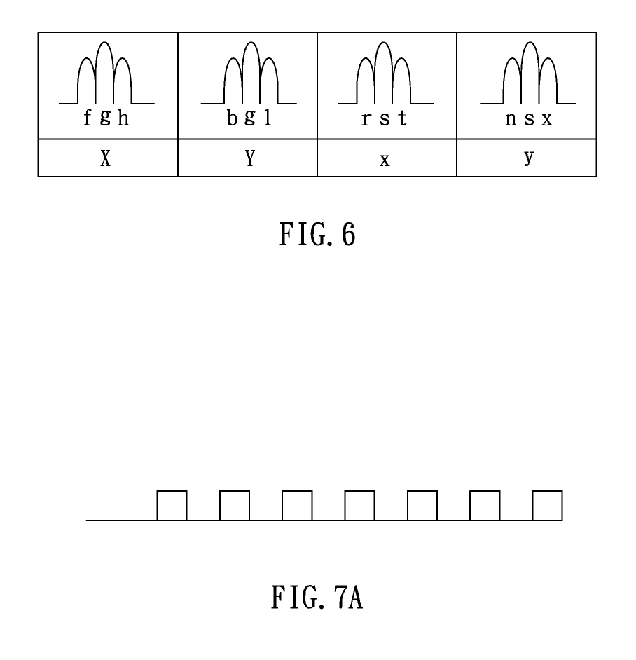

When the input pen 3 with the ferrite core 30 or the input pen 3′ and the non-straight ferrite core 34 are used with the antenna loops shown in FIGS. 5A-5C, the coordinates of the tip of the input pen can be calculated by acquiring check loops sensing the peak values of signal waveform by the firmware or software of the electromagnetic input apparatus. FIG. 5C shows that the check loops g and will sense the peak values of signal waveform when an input pen such as the input pen 3 with the ferrite core 30 or the input pen 3′ and the non-straight ferrite core 34 are used on the check loops a˜y of the multi-check antenna loops. The coordinate of the check loops g and s can be calculated through the peak values of signal waveform sensed at the check loops f, h, b and l, and r, t, n and x respectively as shown in FIG. 6. The x coordinate of the check loop g can be calculated through the maximum peak value sensed at the check loop g and the secondary peak values sensed at the check loops f and h. The y coordinate of the check loop g can be calculated through the maximum peak value sensed at the check loop g and the secondary peak values sensed at the check loops b and l. The x coordinate of the check loop s can be calculated through the maximum peak value sensed at the check loop s and the secondary peak values sensed at the check loops r and t. The y coordinate of the check loop s can be calculated through the maximum peak value sensed at the check loop s and the secondary peak values sensed at the check loops n and x. The width and the coordinate of the input pen's tip can be calculated by the following equation:

$$width = \sqrt{{( {X}^{′} - {X}^{″} )}^{2} + {( {Y}^{′} - {Y}^{″} )}^{2}}$$

$$center ( X , Y ) = ( \frac{{X}^{′} + {X}^{″}}{2} , \frac{{Y}^{′} + {Y}^{″}}{2} )$$

The width and the coordinate of the center of the input pen's tip can be calculated by the following equations:

$$width = \sqrt{{( {g}_{x} - {s}_{x} )}^{2} + {( {g}_{y} - {s}_{y} )}^{2}}$$

$$center ( X , Y ) = ( \frac{{g}_{X} + {s}_{X}}{2} , \frac{{g}_{y} + {s}_{y}}{2} )$$

The coordinates (gₓ, g_{y}) and (sₓ,s_{y}) of the check loops g and s can be calculated by the above-mentioned equation and the width and the coordinate of the center of the input pen's tip can be calculated.

Since each of the check loops in FIGS. 5A-5C has a switch and is independent, error of the recognition of signal strength can be avoided comparing to the antenna loops in FIGS. 2A to 2C. When an input pen is placed adjacent the check loops g and s in FIG. 5C, the check loop g would sense the maximum peak values of electromagnetic signals, and the adjacent check loops f, h, and the adjacent check loops b, l would sense the secondary peak values of electromagnetic signals along x and y axes respectively. The check loop s would sense the maximum peak values of electromagnetic signals, and the adjacent check loops r, t, and the adjacent check loops n, x would sense the secondary peak values of electromagnetic signals along x and y axes respectively.

Thus the coordinates and movement of the input pen can be calculated and recognized through the signals sensed at the check loops g and s, and the adjacent check loops f, h, b and l of the check loop g, and the adjacent check loops r, t, n and x of the check loop s. Therefore, the posture including twist and tilt motions of an input pen can be precisely identified without recognition error of signal strength.

FIG. 7A shows a loop of the checkerboard loops (N=2). FIG. 7B shows checkerboard loops along x axis (left) and y axis (right) respectively. FIG. 7C shows the complete checkerboard loops which needs 16 switches. FIG. 8A shows a loop of the checkerboard loops (N=4). FIG. 7B shows checkerboard loops along x axis (left) and y axis (right) respectively. FIG. 7C shows the complete checkerboard loops which needs 16 switches.

FIG. 8A shows a loop of the checkerboard loops (N=4). FIG. 8B shows checkerboard loops along x axis (top) and y axis (bottom) respectively. FIG. 8C shows the complete checkerboard loops which needs 32 switches.

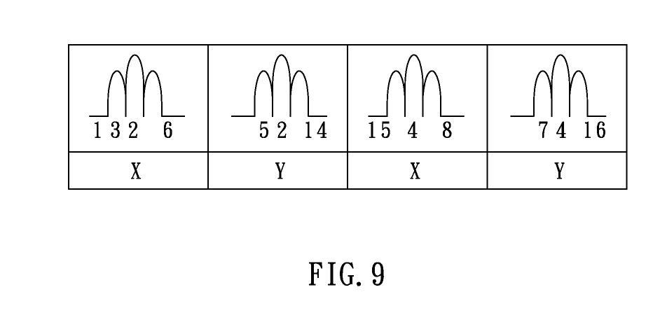

When the input pen 3 with the ferrite core 30 or the input pen 3′ and the non-straight ferrite core 34 are used with the antenna loops shown in FIGS. 8A-8C, the coordinates of the tip of the input pen can be calculated by acquiring check loops sensing the peak values of signal waveform by the firmware or software of the electromagnetic input apparatus. FIG. 8D shows that the check loops B˜D (designated as reference numbers 2˜4) will sense the peak values of signal waveform when an input pen such as the input pen 3 with the ferrite core 30 or the input pen 3′ and the non-straight ferrite core 34 are used on the loops 1˜15 of the checkerboard antenna loops. The x coordinate of the check loop B (designated as reference number 2) can be calculated through the maximum peak value sensed at the check loop B and the secondary peak values sensed at the check loops (designated as reference numbers 6 and 13). The y coordinate of the check loop B can be calculated through the maximum peak value sensed at the check loop B and the secondary peak values sensed at the check loops (designated as reference numbers 5 and 14). The x coordinate of the check loop D (designated as reference number 4) can be calculated through the maximum peak value sensed at the check loops and the secondary peak values sensed at the check loops (designated as reference numbers 8 and 15). The y coordinate of the check loop D can be calculated through the maximum peak value sensed at the check loop D and the secondary peak values sensed at the check loops (designated as reference numbers 7 and 16). FIG. 9 shows that the coordinates of the check loops B and D can be calculated through the peak values of signal waveform sensed at the check loops designated as the illustrated reference numbers. The width and the coordinate of the input pen's tip can be calculated by the following equation:

$$width = \sqrt{{( {B}_{x} - {D}_{x} )}^{2} + {( {B}_{y} - {D}_{y} )}^{2}}$$

$$center ( X , Y ) = ( \frac{{B}_{X} + {D}_{X}}{2} , \frac{{B}_{y} + {D}_{y}}{2} )$$

Since each of the loops in FIGS. 7A-7C and FIGS. 8A-8C has a plurality of check loops and a switch, and each check loop and its adjacent check loops are connected to separate switches, error of the recognition of signal strength can be avoided comparing to the antenna loops in FIGS. 2A to 2C. When an input pen is placed adjacent the check loops B˜D (designated as reference numbers 2˜4) in FIG. 8D, the check loop B (designated as reference number 2) would sense the maximum peak values of electromagnetic signals, and the adjacent check loops (designated as reference numbers 13 and 6), and the adjacent check loops (designated as reference numbers 5 and 14) would sense the secondary peak values of electromagnetic signals along x and y axes respectively. The check loop D (designated as reference number 4) would sense the maximum peak values of electromagnetic signals, and the adjacent check loops (designated as reference numbers 15 and 8) and the adjacent check loops (designated as reference numbers 7 and 16) would sense the secondary peak values of electromagnetic signals along x and y axes respectively. Since the check loops (designated as reference numbers 13, 6, 5 and 14) adjacent the check loop B (designated as reference number 2) would sense the secondary peak values of electromagnetic signals along x and y axes respectively, other check loops (designated as reference number 2) of the same loop of the checkerboard loops connecting to the same switch would not be identified as the location of the input pen. Similarly, the check loops (designated as reference numbers 15, 8, 7 and 16) adjacent the check loop D (designated as reference number 4) would sense the secondary peak values of electromagnetic signals along x and y axes respectively, other check loops (designated as reference number 4) of the same loop of the checkerboard loops connecting to the same switch would not be identified as the location of the input pen. Thus the coordinates and movement of the input pen can be calculated and recognized through the signals sensed at the check loops B and D (designated as reference numbers 2 and 4), and the adjacent check loops (designated as reference numbers 13, 6, 5 and 14) of the check loop B (designated as reference number 2), and the adjacent check loops (designated as reference numbers 15, 8, 7 and 16) of the check loop D (designated as reference number 4). Therefore, the posture including twist and tilt motions of an input pen can be precisely identified without recognition error of signal strength.

In the embodiments of the inventions, the multi-angle electromagnetic input apparatus utilizes input pens have a ferrite core arranged along the breadthways direction of the input pen or a ferrite core with a varied shape to change the direction of the magnetic lines of force and multi-check antenna loops and/or checkerboard antenna loops. The multi-angle electromagnetic input apparatus uses the maximum peak value and the secondary peak values of waveform distribution to locate and calculate the coordinates of the width and center of the input pen so that the posture of the input pen including twist and tilt motion or the effect of multi-angle input can be presented

Although specific embodiments have been illustrated and described, it will be appreciated by those skilled in the art that various modifications may be made without departing from the scope of the present invention, which is intended to be limited solely by the appended claims.

What is claimed is:

1. An electromagnetic input apparatus comprising:
an input pen with a ferrite core coiled with a coil arranged along the breadthways direction of the input pen; and
an electromagnetic sensor board with antenna loops, the antenna loops having a plurality of check loops arranged in column or row so that the electromagnetic sensor board is divided into a plurality of regions each of which is enclosed by the check loop.

2. The electromagnetic input apparatus according to claim 1, wherein the check loop does not overlap each other.

3. The electromagnetic input apparatus according to claim 1, wherein each the check loop has a switch.

4. The electromagnetic input apparatus according to claim 1, wherein the ferrite core comprises a straight ferrite core.

5. The electromagnetic input apparatus according to claim 1, wherein the ferrite core comprises a non-straight ferrite core with both ends toward a tip of the input pen.

6. The electromagnetic input apparatus according to claim 5, wherein the non-straight ferrite core comprises a U-shape ferrite core.

7. An electromagnetic input apparatus comprising:
an input pen with a ferrite core coiled with a coil arranged along the breadthways direction of the input pen; and
an electromagnetic sensor board with an antenna loop, the antenna loops having a plurality of loops arranged along coordinate axes, each loop arranged in column or row and enclosing W/N regions so that the electromagnetic sensor board is divided into a plurality of the regions, wherein W is the width or length of the electromagnetic sensor board, N is the distance between two adjacent regions.

8. The electromagnetic input apparatus according to claim 7, wherein the loop does not overlap each other.

9. The electromagnetic input apparatus according to claim 7, wherein the ferrite core comprises a straight ferrite core.

10. The electromagnetic input apparatus according to claim 7, wherein the ferrite core comprises a non-straight ferrite core with both ends toward a tip of the input pen.

11. An antenna loop of an electromagnetic input apparatus comprising:
a plurality of loops arranged in column or row so that an electromagnetic sensor board of the electromagnetic input apparatus is divided into a plurality of regions each of which is enclosed by the loop.

12. An antenna loop of an electromagnetic input apparatus comprising:
a plurality of loops arranged along coordinate axes, each loop arranged in column or row and enclosing W/N regions so that an electromagnetic sensor board of the electromagnetic input apparatus is divided into a plurality of the regions, wherein W is the width or length of the electromagnetic sensor board, N is the distance between two adjacent regions.

13. An input pen of an electromagnetic input apparatus comprising a ferrite core coiled with a coil arranged along the breadthways direction of the input pen.

14. An input pen of an electromagnetic input apparatus comprising a U-shape ferrite core coiled with a coil with both ends toward a tip of the input pen.
